(19) United States
(12) Patent Application Publication
(10) Pub. No.: US 2003/0135762 A1
(43) Pub. Date: Jul. 17, 2003

(54) Wireless networks security system

(75) Inventor: Tyson Macaulay, Ottawa (CA)

Correspondence Address: SUGHRUE MION, PLLC, 2100 PENNSYLVANIA AVENUE, N.W., WASHINGTON, DC, 20037, US

(73) Assignee: PEEL WIRELESS, INC.

(21) Appl. No.: 10/323,728

(22) Filed: Dec. 20, 2002

Related U.S. Application Data
(60) Provisional application No. 60/346,292, filed on Jan. 9, 2002.

(51) Int. Cl. G06F 11/30

(52) U.S. Cl. 713/201

(57) ABSTRACT

An IEEE 802.11 security system for monitoring wireless networks with a view to detecting and locating unauthorized or threatening IEEE 802.11 devices entering a user's wireless network environment or a facility not intended to support wireless networks is disclosed. The security system comprises a network appliance subsystem and a portable computing subsystem with data means to interface between the two systems. Optionally, counter-measuring means for launching neutralizing and/or disabling counter-measures against a suspected device upon activation can be incorporated into the security system. A method of operation of the IEEE 802.11 security system is also disclosed.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2002, Peel Wireless.

### FIELD OF THE INVENTION

This invention relates to security automation system directed to IEEE 802.11a, IEEE 802.11b and IEEE 802.11g (henceforth “IEEE 802.11”) wireless networks.

### BACKGROUND OF THE INVENTION

Wireless communication is undergoing a rapid technological transformation, resulting in vastly increased potential for new services and applications. New transmission techniques known as Wireless Local Area Network WLAN (IEEE 802.11b/a/g), Bluetooth and 3^{rd} Generation mobile phones—3G (UMTS, CDMA2000) represent dramatic changes in wireless service-capabilities. These technologies such as WLAN and 3G bring bandwidth to wireless devices on par with contemporary fixed-line Ethernet solutions available in homes and offices.

As wireless communication gains popularity, a significant demand will unfold for wireless security. Security will need to be enhanced in many different areas: transmission security, wireless gateway security, transaction authentication (digital signatures) and mobile device security.

WLAN technology offers many advantages in terms of productivity and cost savings, however, it will be constantly exposed to threats. WLAN will be exposed to new threats presented by broadcast features of radio carriers: the ability of any device in range to contact or eavesdrop on communications through radio carrier signals. WLANs also make it possible for entities to very easily, possibly accidentally, bypass the contemporary firewalls and routers business has come to rely on. Referring to FIG. 1, Intruder 100 works to gain access to Network Coverage 102. Intruder 100 comes within a few hundred feet of the WLAN Access Point 118 located within Office Building 110 to attempt to “associate” to gain network access or simply monitor traffic. WLAN 112 signals are then subject to eavesdropping, masquerade and denial of services by Intruder 100, thus placing Mobile Users 120 and other corporate assets on the Ethernet LAN 114 and Internal Workstations 116 at risk. As a result, wireless devices will require types of security and safeguards beyond those that have been developed for the fixed-line network world.

Intrusion Detection System (“IDS”) is an analysis entity on a network that monitors traffic for anomalies that indicate an attempt to compromise the network. Monitoring can take many forms and spans from low-level inspection of the “source” and “destination” of data, to inspecting the contents of data packets as they travel across the network to monitoring activity on a specific host. An IDS will take this information and compare it to rules and heuristics. A match between a data stream or system operation and a rule may indicate a compromise or attack in progress. The IDS will then react to this information in a wide variety of ways: from sounding alarms to possibly launching automatic network defense counter-measures.

The IDS is often considered both the first line of defense and the last line of defense in network security. They are sentries on either side of the network perimeter and/or located on host computers intended to look for attempts to penetrate or compromise the network perimeter or a host computer. IEEE 802.11 networks require IDS-like systems specific to the lower MAC layer management element (as defined by the seven layer OSI model). These services are not present in traditional IDS services. These security services are especially important because of the ease of tapping into wireless networks—simply walk/drive/dig/fly/courier a “probe” within a hundred meters of these networks. Similarly, it is desirable to have IDS-like systems which enable organizations to centrally implement, manage, monitor and maintain wireless security for either clients or employees. These products will be crucial to protection of client and corporate assets.

Due to the wide acceptance of the IEEE 802.11 networks, security products for WLANs operating under these specifications are particularly advantageous. Any such security products must be able to detect the presence of malicious, compromised, malfunctioning or “lost” mobile devices. Such products also need to provide tools to locate and neutralize the unauthorized, compromised, malfunctioning or lost devices, which would otherwise be nearly impossible to locate due to the ease of concealing wireless devices.

### SUMMARY OF THE INVENTION

This invention addresses the shortcomings of the current security concerns over wireless technologies identified herein.

More particularly, the wireless security system according to the present invention enables users to detect and neutralize unauthorized or defective 802.11 devices and pin-points their physical location so they can be removed before damage is done.

The name given to the wireless security technology of the present invention is Wireless Integrity Technology (“WIT”). WIT will automatically detect an unauthorized or defective device entering a WLAN or a facility not intended to support WLAN, and will then monitor this device's activity and locate and neutralize the device. The security services provided by WIT rapidly determine the intentions of a new device. If it begins suspicious or malicious activities, the administrator is immediately notified. Furthermore, by employing the WIT software in combination with a specially developed antenna system, the physical location of the intruding device is precisely established. Additionally, the neutralization capabilities of the system allow for automatic, remote counter-measures against the intruding device. Consequently, the operators have the opportunity to physically intervene against the unauthorized, compromised or defective device.

Accordingly, the present invention provides for an IEEE 802.11 security system for monitoring wireless networks and detecting, neutralizing and locating unauthorized or threatening IEEE 802.11 devices. The security system comprises a network appliance subsystem and a portable computing subsystem, wherein the network appliance subsystem comprises:

signal processing means for detecting and monitoring IEEE 802.11 signals;

analytical means for analysing information gathered from the unauthorized or threatening IEEE 802.11 devices and determining nature of security breach;

alerting means for alarming administrative staff of the unauthorized or threatening IEEE 802.11 devices;

and said portable computing subsystem comprises:

a directional antenna for locating said unauthorized or threatening IEEE 802.11 devices; and

signal processing means for managing IEEE 802.11 interface and interpreting information gathered by said directional antenna and data means to interface between said network appliance subsystem and said portable computing subsystem.

The present invention further provides for a method for monitoring IEEE 802.11 wireless networks and detecting, neutralizing and locating unauthorized or threatening IEEE 802.11 devices. The method comprising interfacing between a network appliance subsystem and a portable computing subsystem, wherein operation of the network appliance subsystem consists of:

sensing an interference or attack from the unauthorized or threatening IEEE 802.11 device;

detecting and monitoring IEEE 802.11 signals with a signal processing means;

analysing information gathered from the unauthorized or threatening IEEE 802.11 devices and determining nature of security breach by an analytical means; and

alarming a user presence of the unauthorized or threatening IEEE 802.11 devices through an alerting means;

and operation of the portable computing subsystem consists of:

locating the unauthorized or threatening IEEE 802.11 devices through a directional antenna; and

managing IEEE 802.11 interface and interpreting information gathered by the directional antenna via a signal processing means.

### BRIEF DESCRIPTION OF THE DRAWINGS

FIG. 1 is a schematic diagram showing how network coverage can be compromised by an outside intruder.

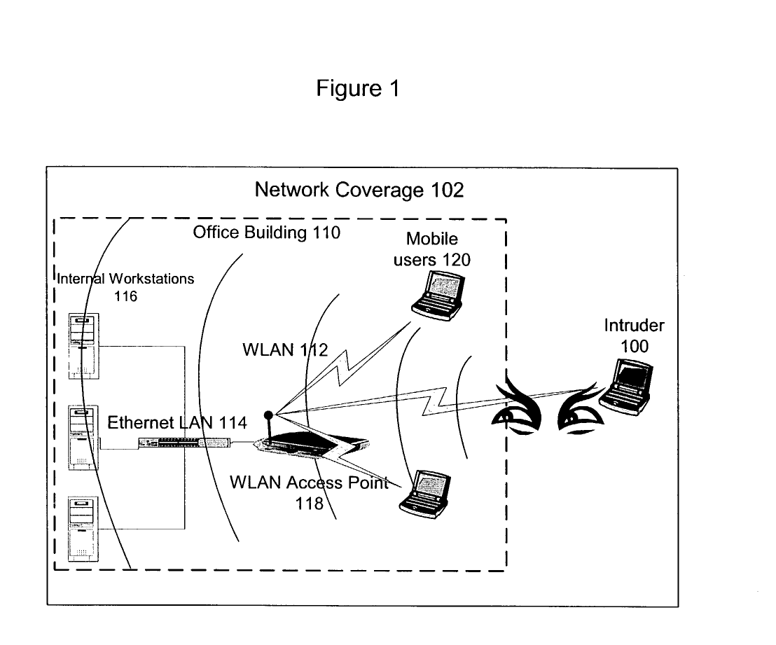

FIG. 2 is a logical diagram of the present invention showing sequential steps in the operational detection and respond to a security risk intruder.

FIG. 3 is a schematic diagram of the present invention showing the counter-measures operations.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

In accordance with the invention, the Wireless Integrity Technology (“WIT”) is designed for use on the IEEE 802.11 wireless networks in general and, on IEEE 802.11b, IEEE 802.11a and IEEE 802.11g wireless networks in particular. However, since these networks have very similar functionality as far as the WIT is concerned and all specifications related thereto apply to all varieties of IEEE 802.11b/a/g.

WIT provides security against a variety of threats to IEEE 802.11 networks such as:

Rogue nodes: IEEE 802.11 devices that attempt to establish, join or disrupt a network for malicious and unauthorized purposes, or devices that try and establish a “booby-trap” network to attract legitimate devices and compromise them

Benign nodes: IEEE 802.11 devices that “wander” or conflict with IEEE 802.11 networks such that they inadvertently impact performance, and must therefore be re-directed, re-configured or removed.

Defective nodes: an IEEE 802.11 device that has become a threat to the network because of a malfunction or misconfiguration.

WIT is not designed to be a general network IDS. Fixed-line network IDS functions and applications are complimentary to WIT in that they pick up where WIT leaves off, providing security at higher layers in the OSI protocol stack.

### SYSTEM DESCRIPTION

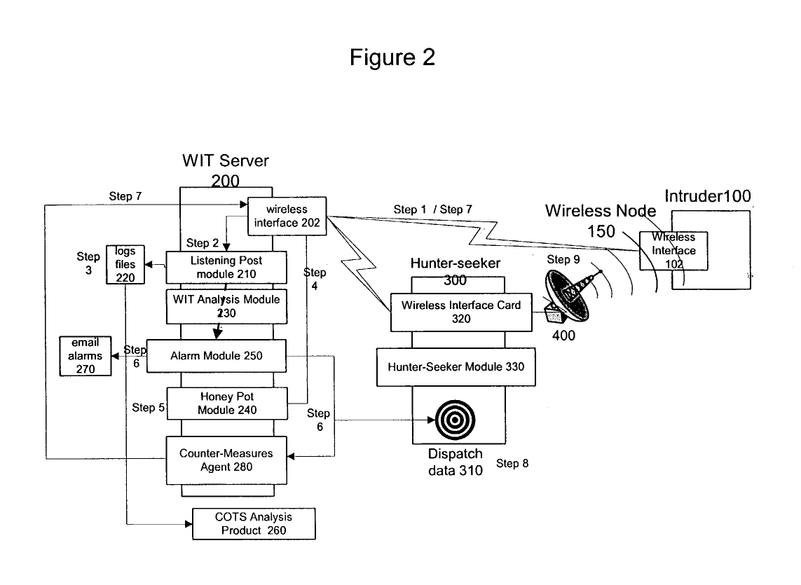

The operations of the present invention are described with the aid of FIG. 2 which outlines the overall concept of operations for the WIT system. The system is comprised of two major functional subsystems, namely the WIT Server subsystem and the Hunter-Seeker subsystem. Each subsystem further consists of a plurality of modules. Preferably, the WIT Server modules reside on the same physical platform. Optionally, these modules may be separated across several different physical platforms but still perform the same functions together.

Referring to FIG. 2, the operational sequences of WIT system is as follows:

Step 1. Attack:

A Wireless Node 150 enters the network from Intruder 100 for the purposes of probing, eavesdropping, attracting or attacking and may attempt to associate with the network or shutdown or jam the network and its signals are perceived on the Wireless Interface 202

Step 2. Listening Post:

The WIT Server 200 is equipped with one or more Wireless Interfaces 202, but is not part of the wireless network. This interface is only to monitor the wireless network(s). Listening Post Module 210 gathers from all IEEE 802.11 radio channels and makes data available for analysis by other modules.

Step 3. Logs:

Log Files 220 are made available to third party applications for visualization and additional analysis. For instance, third party intrusion detection system tools for additional analysis or database tools for reporting.

Step 4. Lookout:

WIT Analysis Module 230 looks for IEEE 802.11-specific attack patterns using real-time analysis and contains configurations related to alert levels and security policy configurations. The WIT Analysis Module 230 has the capability to support active counter-measures as can be seen from the “Honey Pot” and Counter-Measure Agent described below.

Step 5. Honey Pot:

The intent of the Honey Pot Module 240 in Step is to provide an “easy” target to decoy intruders—which will set-off alarms and distract them with “bait” files supplied by WLAN system administrators. The Honey Pot Module 240 will maintain detailed logs for evidentiary purposes and be connected to the WIT Alarm Module 250.

Step 6. Alarm Generation:

Alarm Module 250 is responsible for generating alarms to users and dispatching tracking information to Hunter-Seeker 300 and/or information to initiate automatic counter-measures from the Counter-Measure Agent 280. Alarm Module 250 interfaces with the internal network to send e-mail alerts to operators or security staff through existing SMTP resources.

Step 7. Counter-Measures

The Counter-Measure Agent 280 is responsible to automatically neutralize suspect IEEE 802.11 devices as defined in the alarm data and for periods defined by administrators. Counter-Measures Agent 280 launches counter-measures through one of multiple Wireless Interfaces 202.

Step 8. Dispatch Messages:

The Alarm Module 250 also interfaces with certificate stores on the server platform to secure Dispatch Data 310 going to Hunter-Seeker 300. Dispatch Data 310 is transmitted over the air or transferred through out-of-band (such as floppy disk) means to a Hunter-Seeker 300. Hunter-Seeker 300 verifies message integrity and learns intruder and/or target parameters.

Alarm Module 250 continues to update Hunter-Seeker 300 with latest data about Intruder 100, or alternately about new intruders. Hunter-Seeker 300 will pick up data in the course of performing searches by directing the antenna towards the WIT Server 200 long enough to receive update files.

Step 9. Directional Node Searches:

Using a Directional Antenna 400, Hunter-Seeker 300 is a manually operated, portable computing device which searches for specific devices through the unique combination of directional capabilities and the Hunter Seeker Module 330 signal processing engine. Hunter-Seeker Wireless Interface Card 320 indicates when targeted (intruder) radio signals are found and indicate signal strength. Directional Antenna 400 interfaces with the expansion port on IEEE 802.11 Wireless Interface Card 320.

As discussed earlier, the IEEE 802.11 WIT is comprised of two distinct hard- and software subsystems: a WIT Server 200 subsystem and a Hunter-Seeker 300 subsystem. Both subsystems perform unique functions through specially developed signal processing engines. In the case of the WIT Server 200, the signal processing engine is represented by the Listening Post Module 210 and the Analysis Module 230. In the case of Hunter-Seeker 300, the specialized signal processing is represented by the Directional Antenna 400 in combination with signal processing software. Additionally, the IEEE 802.11 WIT prepares data for input directly into Commercial Off-The-Shelf (“COTS”) Analysis Products 260 for the purposes of visualization and additional analysis in Hunter Seeker Module 330.

Counter-Measure Agent

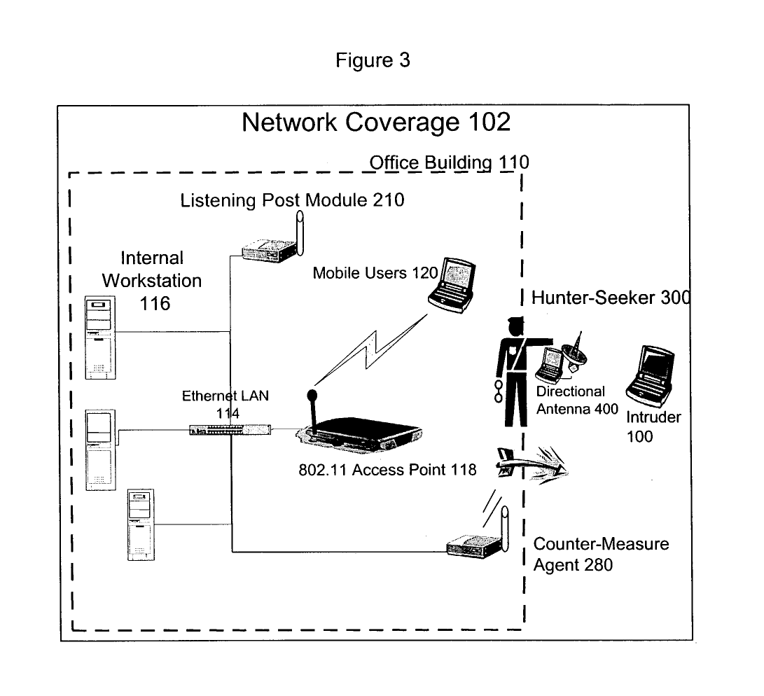

Referring to FIG. 3, the Counter-Measure Agent 280 is a complimentary module which may be integrated with, or physically separate from, the Listening Post Module 210. It constitutes the counter-measure means of the present invention and launches neutralizing and/or disabling counter-measures against the suspected unauthorized device upon activation. The Counter-Measure Agent 280 is activated either automatically by alerts from the Alarm Module 250 or through system administrator commands. The primary objective of the Counter-Measure Agent 280 is to automatically launch neutralizing, radio frequency and protocol-based counter-measures against unauthorized devices until an administrator can respond to the alarm and make a positive or negative determination of the intent of the device(s).

The Counter-Measure Agent 280 has the following characteristics:

The Counter-Measure Agent 280 can be installed and run from either a stationary server appliance or from a portable device. A stationary server appliance is preferred since it has a greater capability to remain on-line at all time.

The Counter-Measure Agent 280 is implemented with high-performance omni-directional or Directional Antennas 400.

The Counter-Measure Agent 280 automatically responds to alarms from the Alarm Module 250 related to either specific devices or specific networks (ESS or IBSS). Therefore the Agent can launch effective counter-measures against individual devices or entire groupings of devices.

System administrators have the capability to manually initiate counter-measures against devices or networks which can be configured into the Counter-Measure Agent 280 directly through a command-line or Graphic User Interface (GUI).

Once a counter-measure has been initiated, it will remain in effect until it has been manually de-activated by an approved administrator, or until a pre-configured expiry period elapses.

Counter-measures will exist in the form of both RF and IEEE 802.11 manipulations which have the impact of either disabling devices or entire networks. The specific type of counter-measure to be launched will be configured by administrators at set-up time, but can be adjusted at a later date.

A list of RF and IEEE 802.11 manipulations which the Counter-Measure Agent 280 is capable of effecting include, but not be limited to, the following types of counter-measures:

Spectrum jamming—The Counter-Measure Agent 280 can emit high-powered RF “noise” intended to shut down IEEE 802.11 channels through the inability of clear signals to be heard about the generated noise. This technique could be useful in environments and situations where all WLAN communications must stop or be prohibited either temporarily or permanently.

Signal dominance—Generation of a stronger signal than the target device or network in order to attract all traffic intended to the suspect device to the Counter-Measure Agent 280 instead. This technique may be used to capture traffic from unauthorized devices.

Protocol manipulation—Examples of IEEE 802.11 protocol manipulations which the Counter-Measure Agent 280 is capable of executing includes, but not be limited to, the following types of counter-measures:

(a) Device-specific—The Counter-Measure Agent 280 can target specific devices based on MAC addresses of these devices. Device-specific attacks inflict denial-of-service attacks by either forcing the device to leave the network and thereby prevent any further communications. These attacks can be achieved through manipulation and generation of specific IEEE 802.11 management or control frames such as “Deauthentication” or “Disassociation” frames. Additionally, Counter-Measure Agent 280 can direct network traffic against a suspect device such that the device is over-whelmed and cannot accept any further data, or in order to exhaust the battery of a mobile intruder.

(b) Network Specific—The Counter-Measure Agent 280 can target specific IEEE 802.11 networks according to the network name or other network-specific feature and shut down all traffic on this network by denying any of the nodes network resources with which to transmit e.g. through constant transmission of “request to send (“RTS”)” and force all other nodes to “back-off” transmitting indefinitely. The Counter-Measure Agent 280 can also specifically target and disable IEEE 802.11 Access Points 118, to shut down a network by removing the core infrastructure component from operation.

Accordingly, Counter-Measure Agent 280 effectively denies Intruder 100 access to Network Coverage 102, thus protecting the Mobile Users 120 and the proprietary information resided at Ethernet LAN 114 and Internal Workstation 116.

### OPERATING ENVIRONMENT

Since the IEEE 802.11 WIT is not a generalized network or host IDS, it specifically focuses on the MAC and Data-link layer of IEEE 802.11 networks. The other higher network layers of transport, session, presentation and application layers fall outside the scope of the preset invention.

The functional aspects of the WIT Server 200 subsystem and the Hunter-Seeker 300 subsystem are now described in detailed with reference to FIG. 2.

Network Appliance—WIT Server Subsystem

The WIT Server 200 subsystem is the core of the 802.11 WIT security system which monitors wireless network traffic for possible intrusions.

The WIT Server 200 subsystem is a network appliance which requires minimal configuration. It is a stand-alone application on a hardened platform.

WIT Server GUI—Server Graphic User Interface

Start-up of all WIT Server 200 subsystems is accomplished through a single controlling WIT Server Graphic User Interface (“GUI”), which requires username and password. Users can be identified as either user administrators or user support staff on all modules. Operationally, a hierarchy of privileges can be assigned to the users. For example, administrators can change configuration settings, while support staff can view but not change settings.

WIT Server GUI is equipped with the capability to display general status information such as:

networks being monitored: Server Set ID (“SSID”), Name, Channels, 802.11 security framework (WEP, 802.1x, WPA, 802.11i)

other networks in range

number of devices on wireless network including details of IP, MAC, Access Points or Peer devices, SSIDs, Channels used, Signal/Noise Strength

whether device is “green” or “red”—authorized or unauthorized

Passwords and Security Verification

For security reasons, passwords should not be stored by the application. Hashes of passwords are to be used for comparison purpose.

WIT has access to a PKI Certificate store for the purposes of digitally signing alarm and status information sent to Hunter-Seeker 300. Preferably, alarm and status data files are signed using keys designated by the administrators.

Listening Post Module

The Listening Post Module 210 constitutes the signal monitoring means of the present invention and generates Log Files 220 at several different levels of detail. Log Files 220 are stored and read to and from either local or network drives. Listening Post 210 logs all data in delimited plain text or standard “tcpdump” format with a specific intent of supporting analysis and display by third-party Analysis Products 260. Typically, logs contain the following data about the results of IEEE 802.11 network analysis and timestamp down to the second or tenth of a second if possible; packet number; source address; destination address; MAC address; SSID and network name; devices manufacturer; security framework; protocol and application information; channel information; and signal strength and noise.

Analysis Module

The WIT Analysis Module 230 constitutes the analytical means of the present invention and is capable of monitoring multiple wireless networks on multiple wireless interfaces 202 from a single WIT Server 200.

The Analysis Module 230 is capable of detecting the following IEEE 802.11 specific events and reporting these events:

| | |
|---|---|
| Net- | the network name which must be used to distinguish one IEEE |
| work | 802.11 network from another in the same range |
| SSID | |
| MAC | the unique identifier for a given node |
| address | |
| Frame | Management Frames |
| infor- | Control Frames |
| mation | Data Frames: pure data streams without any |
| | management information available |
| Infor- | other information about the network or device which may have |
| mation | been configured and is carried in management frames |
| Channel | the IEEE 802.11 channel being used by the device; channels |
| | range from 1 to 11 in North America |
| Security | verify whether Wireless Equivalent Privacy (WEP), 802.1x, |
| Frame- | Wireless Protected Access (WPA) or 802.11i is being used to |
| work | encrypt the data stream |
| Data | the negotiated speed of the connection between devices as |
| rate | support by IEEE 802.11b: 2 Mbps, 5.5 Mbps, 11 Mbps |
| Traffic | the number of packets observed from the given device; packets |
| rates | are categorized as follows: |
| | LLC - IEEE 802.11 link layer control packet |
| | Data - 802.3 data packets |
| | Total = running total of all packets observed |
| First/ | the first time the device was observed and the latest observation |
| last | time |
| appear- | |
| ance | |

Analysis Module 230 allows for configuration of which events are considered threats. Numerous specific attacks are monitored: unauthorized association, attempted association, jamming, sabotage, network lurking, device masquerade, man-in-the-middle, ARP and MAC address spoofing, WEP cracking, Denial-of-Service (DOS) attacks and IEEE 802.11 protocol manipulation. These are explained as follows:

Unauthorized Association—a device with is not intended to access the wireless resources successfully joins the IEEE 802.11 network and has access to higher-level protocols and applications.

Attempted Association—an unauthorized device attempts to discover the necessary configuration elements to join the wireless network, or unsuccessfully presents credentials in an attempt to gain access to higher level resources.

Jamming—a device emits copious, or extraneous IEEE 802.11 frames in order to consume network resources.

Sabotage—a device emits IEEE 802.11 management or control frames in an attempt to paralyze the network as a whole or individual devices.

Network Lurking—Network lurking refers to detection of hosting sitting on the subnet but without any traffic being generated. The WIT is capable of distinguishing a node which has “stumbled” on the network and mistakenly tries to send data (e.g. using incorrect subnet configurations) from “lurking” nodes with forged or no IPs defined but MAC address visible.

Masquerade—Detection of a device that attempts to override another by assuming the same IP and broadcasting a stronger signal, such that traffic intended for legitimate device arrives at the rogue device. WIT looks for duplicate IP addresses on the network and differentiates the “new” device from the “original” device based on MAC addresses in ARP messages. Alternately, a MAC address can be forged. If two devices with the same MAC address appear on the net, one or the other is deliberately faked since MACs are hardware unique.

Access Point Masquerade—Another device attempt to broadcast a IEEE 802.11 management frames with the same or different SSID and IP address as a legitimate access point.

Man-In-The-Middle (“MITM”)—Man-In-The-Middle attacks consist of masquerade, but with the added threat that information is then forwarded onto the original destination such that neither end of the connection is aware of interference or changes to packet content.

Wireless Equivalent Privacy (“WEP”) Cracking—Tools which are publicly available to crack WEP keys in 1 gigabyte of data can be gathered from the network. In addition to detecting lurkers, the WIT looks for devices attempting to join the network with the correct WEP key but without knowing network configuration information or, optionally, performing no network operations after joining.

Station-to-Station—Traffic from one wireless station to another could indicate that an attack is being launched over the wireless Ethernet from one mobile station to another. For instance, port scans.

DOS—A wide range of DOS attacks are available to an entity that can get in range of the network. The following DOS attack methods are of primary concern, namely flooding the network with data to consume all bandwidth; protocol-based sabotage and jamming from conflicting networks.

IEEE 802.11 Protocol Manipulation—The techniques used in Counter Measure Agent 280 can be potentially mimicked by malicious entities. WIT will recognize such attacks.

Hunter-Seeker dispatch settings are configured into Alarm Module 250 by system administrators (see discussions below). Typically, configuration features for Hunter-Seeker 300 include:

Multiple Hunter-Seekers—Multiple Hunter-Seekers are supported from a single WIT Server. These can be dispatched individually or all at once.

MAC address—Hunter-Seekers are being identified on the network using MAC address in ARP requests, which will be cross-referenced with the expected IP.

IP Address—Hunter-Seekers will be identified by MAC address and IP address.

Signature Key—All dispatch information are signed by the WIT server. A key within the Windows certificate store is also selected.

As a general requirement, all configuration details must be supplied in order to complete configuration.

Alarm Module

Multiple alarm types from the Alarm Module 250 are displayed in the GUI and are available for sending out via e-mail or pager. Alarm Module 250 constitutes the alerting means of the present invention and provides for three ranges of alarms, namely, Critical, Important, Suspicious. The three ranges are further described as follows:

Critical

DOS attacks

node has successfully joined using WEP but sends incorrect login data such as network name

MITM

rogue access point identified

sabotage or jamming

Important

nodes appear to be “lurking”

DOS from nodes which have come in range but broadcast different network advertisements

repeated, failed attempts to join network

Suspicious

nodes which have come in range but broadcast different network advertisements

Two types of alarms can be generated by Alarm Module 250:

E-mail Alarms—E-mail Alarms 270 are sent out via SMTP to possible several configurable addresses. Alarms may include the following data: alarm level; time; network name; category of intrusion or attack; and log information.

GUI Alarms—The GUI supports configuration to automatically pop-up alarm windows once alarms are triggered.

Information from the WIT Analysis Module 230 is formatted by Alarm Module 250 for use by the Hunter-Seeker Module 330 and Counter Measure Agent 280. This information may contain the following data: MAC address of the suspicious device; channel, if available; type of attack; start time; subject of attack, if applicable, including IP and MAC of subject; signal strength from listening post; and name of listening post, if multiple listening posts available.

Not all data is required to issue a dispatch. At a minimum, MAC address information is required to send Dispatch Data 310 to a Hunter-Seeker 300 or Counter Measure Agent 280. This Dispatch Data 310 is placed in a delimited-format file for parsing by the Hunter-Seeker 300 or Counter Measure Agent 280.

Dispatch Data 310 files are either transferred to floppy disk or optionally transmitted to Hunter-Seeker 300 directly over the IEEE 802.11 network or over the Ethernet LAN to Counter Measure Agent 280. If transmitted, the information will be re-transmitted at a regular interval, e.g. every minute. If the wireless network is down due to attack, data can be transferred using floppy disk. WIT Server 200 checks the wireless network for access to Hunter-Seeker 300 and will continue to attempt updates regularly.

Transmissions of data to Hunter-Seeker 300 or Counter Measure Agent 280 require security. WIT Server 200 has the ability to transmit dispatch data to Hunter-Seeker 300 and Counter Measure Agent 280 which is digitally signed.

Honey Pot Module

Honey Pot Module 240 constitutes the decoying means of the present invention and its configurations are set in advance by a system administrator. The Honey Pot Module 240 can either be running all the time or can be activated automatically as a counter-measure. Honey Pot Module 240 uses a WLAN Interface 202 and imitates an IEEE 802.11 Access Point. If necessary, Honey Pot Module 240 will provide a forged MAC address and broadcast the necessary ARP messages. Honey Pot Module 240 may operate either on the same channel or a different channel from the legitimate access point. Honey Pot Module 240 broadcasts IEEE 802.11 management frames with an unprotected SSID. Honey Pot Module 240 allows association from any device. An alternate configuration for the Honey Pot Module 240 is to configure moderate security to test the capabilities of the attackers.

Honey Pot Module 240 logs all data on activities from connected nodes for evidentiary purposes and issues a call to the Alarm Module 250 once activity commences.

Optically, it provides a deceptive means for tricking lurking, unauthorized or eavesdropping IEEE 802.11 devices into revealing themselves by attempted associations with Honey Pot Module 240.

Portable Computing Subsystem—Hunter Seeker Subsystem

The various components of the Hunter Seeker subsystem 300 are described as follows:

Hunter-Seeker Module

The Hunter-Seeker Module 330 constitutes of the signal processing means for managing IEEE 802.11 tracking interface and interpreting information gathered by Directional Antenna 400 in accordance with the present invention. The Hunter-Seeker Module 330 runs on a portable device such as a laptop or palmtop with the ability to accommodate an 802.11 card.

Target nodes are configurable either through Alarm Module 250, Dispatches Data 310 or through manual input directly via the Hunter-Seeker subsystem 300 GUI. Configuration information is defined in the Alarm Module 250 functional requirements since Alarm Module 250 is responsible for formatting Dispatch Data 310.

If multiple nodes with the same IP or MAC or other configuration parameters are found, Hunter-Seeker subsystem 300 will prompt the system administrator for which node to track. Optionally, all nodes which match the criteria can be tracked. More than one node can be identified for tracking, with the Wireless Interface Card 320 indicating the signal strength of multiple nodes at the same time.

The Hunter-Seeker subsystem 300 reads from an IEEE 802.11 card in monitor mode and dynamically filters out all traffic unrelated to the target device(s) prior to displaying any information in the GUI. The interface displays when a signal is being received from one of the target nodes including the following details about the signal, namely Signal/Noise strength; IP address and subnet; MAC address; Channel; Applications and Protocols in use; Destination of packets; SSID and Network Name; Management frame information (if applicable).

All variables except signal strength are always displayed as last known values. Signal strength is updated as often as feasible as the Directional Antenna 400 picks up and loses the signal.

The Hunter-Seeker subsystem 300 verifies digital signature archives on Dispatch Data 310 information delivered from the Alarm Module 250. Successfully verified files have signature information displayed for manual confirmation by operators. After confirmation, the configuration data is loaded into Hunter-Seeker subsystem 300. If Hunter-Seeker subsystem 300 is already loaded with configuration data for a target device, the user is being prompted to either overwrite the current data or load the new data as an additional device to track.

Configurations and Dispatch Data 310 information can be saved once entered, or changed. Configuration information files can be reloaded into Hunter-Seeker subsystem 300. In addition, Hunter-Seeker subsystem 300 data can be manually purged by the user with all settings back to null. Hunter-Seeker subsystem 300 is also capable of multiple logging levels which can be recorded in delimited text files in user-specified locations. Default location is a directory called “logs” off the install directory of Hunter-Seeker subsystem 300, but location can be manually configured by users.

Logging levels according to the present invention are as follows:

| | |
|---|---|
| None | No logs kept B default setting. |
| Limited | Start time |
| | Manual configuration or data from WIT Server |
| | Successful or failed verification of data from WIT Server |
| | Value of configuration data loaded |
| | Purge of data |
| | Shutdown |
| Extensive | All elements of “Limited”, plus |
| | TCP-dump style data from received data about the target |
| | node |
| | Signal strength from target node |
| Heavy | All elements of “Extensive”, plus |
| | Promiscuous dump of all information picked-up by antenna |

Antenna Specifications

Directional Antennas 400 for the purposes of operating this inventive IEEE 802.11 WIT system are custom made in accordance with the following specifications.

The antennas possess high gain and a narrow sensitivity field in the horizontal and vertical plains. Signals directly in front of the antenna appear strongest, but rapidly fade once the antenna is not pointed at the source of the signal. Thus a strong signal indicates the correct direction of the IEEE 802.11 node while a weak or no signal indicate the “wrong” direction.

The Directional Antenna 400 interfaces with IEEE 802.11 networks through a wide variety of available, off-the-shelf or customized hardware. The WIT system relies on the physical interface provided by IEEE 802.11 system makers. For instance, an Orinoco™ PCMCIA card with an interface for external antennas. The WIT system antennas connect to the off-the-shelf IEEE 802.11 radio through this means.

The Directional Antenna 400 itself may be a variety of different designs. Any antenna possessing significant directional capabilities is acceptable, such as a patch array antenna, multi-dipole antenna and yagi antenna.

The Directional Antenna 400 may be mounted on the back of a laptop computer such that the VGA display is directly “behind” the antenna. This allows the operator to walk forward while watching readings from the Hunter-Seeker subsystem 300 change in real time. Alternatively, the antenna many be handheld and turned to face the strongest signal with one hand while the operator watches signal strength from the Hunter-Seeker subsystem 300 software GUI.

Commercial Off-the-Shelf (“COTS”) Packages

COTS packages are suggested merely as an example. There is no dependencies upon any other software. COTS may include:

Silent Runner from Raytheon: used for visualization of WIT data

IIS used for IDS analysis

Open Source tools

Network Interfaces

IEEE 802.11 WIT server subsystem is required to interface with minimum of one wireless network interface but multiple interfaces are supported. An interface with a second, fixed line network will also be required for accessing other network resources like SMTP for alerts and file server for log storage.

Depending on the sought-after device, the WIT Hunter-Seeker subsystem maintains one network interface through on-board or PCMCIA-type IEEE 802.11 radios. This interface will be for the Directional Antenna to receive signals from sought-after devices.

While the present invention has been described and illustrated herein with reference to the preferred embodiment thereof it will be understood by those skilled in the art that various changes in form and details maybe made therein without departing from the spirit and scope of the invention.

It is to be understood that the embodiments and variations shown and described herein are merely illustrative of the principles of this invention and that various modifications may be implemented by those skilled in the art without departing from the scope and spirit of the invention.

What is claimed is:

1. An IEEE 802.11 security system for monitoring wireless networks and detecting, neutralizing and locating unauthorized or threatening IEEE 802.11 devices, said security system comprising a network appliance subsystem and a portable computing subsystem, wherein,
said network appliance subsystem comprises:
signal processing means for detecting and monitoring IEEE 802.11 signals;
analytical means for analysing information gathered from said unauthorized or threatening IEEE 802.11 devices and determining nature of security breach; and
alerting means for alarming administrative staff of said unauthorized or threatening IEEE 802.11 devices;
and said portable computing subsystem comprises:
a directional antenna for locating said unauthorized or threatening IEEE 802.11 devices; and
signal processing means for managing IEEE 802.11 interface and interpreting information gathered by said directional antenna and data means to interface between said network appliance subsystem and said portable computing subsystem.

2. An IEEE 802.11 security system for monitoring wireless networks and detecting, neutralizing and locating unauthorized or threatening IEEE 802.11 devices, said security system comprising a network appliance subsystem and a portable computing subsystem, wherein,
said network appliance subsystem comprises:
signal processing means for detecting and monitoring IEEE 802.11 signals;
analytical means for analysing information gathered from said unauthorized or threatening IEEE 802.11 devices and determining nature of security breach;
alerting means for alarming administrative staff of said unauthorized or threatening IEEE 802.11 devices;
decoying means for distracting and alluring the attention of said unauthorized or threatening IEEE 802.11 devices; and
deceptive means for tricking lurking, unauthorized or eavesdropping IEEE 802.11 devices into revealing themselves by attempted associations with said decoying means;
and said portable computing subsystem comprises:
a directional antenna for locating said unauthorized or threatening IEEE 802.11 devices; and
signal processing means for managing IEEE 802.11 interface and interpreting information gathered by said directional antenna and data means to interface between said network appliance subsystem and said portable computing subsystem.

3. The IEEE 802.11 security system of claim 1, further comprising means for counter-measuring security breaches initiated by the unauthorized or threatening IEEE 802.11 devices, said counter-measuring means operatively interfacing with said network appliance subsystem and launches neutralizing and/or disabling counter-measures against a suspected device upon activation.

4. The IEEE 802.11 security system of claim 2, further comprising means for counter-measuring security breaches initiated by the unauthorized or threatening IEEE 802.11 devices, said counter-measuring means operatively interfacing with said network appliance subsystem and launches neutralizing and/or disabling counter-measures against a suspected device upon activation.

5. The IEEE 802.11 security system of claim 1, said system is directed to IEEE 802.11 WLAN in general.

6. The IEEE 802.11 security system of claim 2, said system is directed to IEEE 802.11 WLAN in general.

7. The IEEE 802.11 security system of claim 5, said system is directed to IEEE 802.11b or IEEE 802.11a or IEEE 802.11g.

8. The IEEE 802.11 security system of claim 6, said system is directed to IEEE 802.11b or IEEE 802.11a or IEEE 802.11g.

9. The IEEE 802.11 security system of claim 1, said nature of security breach being covered by the system includes unauthorized association, attempted association, jamming, sabotage, network lurking, masquerade, access point masquerade, Man-In-The-Middle, Wireless Equivalent Privacy (WEP) breaches, Station2Staion attacks and Denial Of Services.

10. The IEEE 802.11 security system of claim 2, said nature of security breach being covered by the system includes unauthorized association, attempted association, jamming, sabotage, network lurking, masquerade, access point masquerade, Man-In-The-Middle, Wireless Equivalent Privacy (WEP) breaches, Station2Staion attacks and Denial Of Services.

11. The IEEE 802.11 security system of claim 3, said counter-measuring means is installed and run from either a stationary server appliance or from a mobile computing device.

12. The IEEE 802.11 security system of claim 4, said counter-measuring means is installed and run from either a stationary server appliance or from a mobile computing device.

13. A method for monitoring IEEE 802.11 wireless networks and detecting, neutralizing and locating unauthorized or threatening IEEE 802.11 devices, said method comprising interfacing between a network appliance subsystem and a portable computing subsystem, wherein,
operation of said network appliance subsystem consists of:
sensing an interference or attack from the unauthorized or threatening IEEE 802.11 device;
detecting and monitoring IEEE 802.11 signals with a signal processing means;
analysing information gathered from said unauthorized or threatening IEEE 802.11 devices and determining nature of security breach by an analytical means; and
alarming a user presence of said unauthorized or threatening IEEE 802.11 devices through an alerting means;
and operation of said portable computing subsystem consists of:
locating said unauthorized or threatening IEEE 802.11 devices through a directional antenna; and
managing IEEE 802.11 interface and interpreting information gathered by said directional antenna via a signal processing means.

14. A method for monitoring IEEE 802.11 wireless networks and detecting, neutralizing and locating unauthorized or threatening IEEE 802.11 devices entering said wireless networks, said method comprising interfacing between a network appliance subsystem and a portable computing subsystem, wherein,
operation of said network appliance subsystem consists of:
sensing an interference or attack from the unauthorized or threatening IEEE 802.11 device via a real-time alerting mechanism;
detecting and monitoring IEEE 802.11 signals with a signal processing means;
analysing information gathered from said unauthorized or threatening IEEE 802.11 devices and determining nature of security breach by an analytical means;
alarming a user presence of said unauthorized or threatening IEEE 802.11 devices through an alerting means; and
distracting and alluring the attention of said unauthorized or threatening IEEE 802.11 devices with decoying means;
and operation of said portable computing subsystem consists of:
locating said unauthorized or threatening IEEE 802.11 devices through a directional antenna; and
managing IEEE 802.11 interface and interpreting information gathered by said directional antenna via a signal processing means.

15. The method for monitoring IEEE 802.11 wireless networks and detecting, neutralizing and locating unauthorized or threatening IEEE 802.11 devices entering said wireless networks of claim 13, said method of operation of said network appliance subsystem further comprises deceptive means for tricking lurking, unauthorized or eavesdropping IEEE 802.11 devices into revealing themselves by attempted associations with said decoying means.

16. The method for monitoring IEEE 802.11 wireless networks and detecting, neutralizing and locating unauthorized or threatening IEEE 802.11 devices entering said wireless networks of claim 14, said method of operation of said network appliance subsystem further comprises deceptive means for tricking lurking, unauthorized or eavesdropping IEEE 802.11 devices into revealing themselves by attempted associations with said decoying means.

17. The method for monitoring IEEE 802.11 wireless networks and detecting, neutralizing and locating unauthorized or threatening IEEE 802.11 devices entering said wireless networks of claims 13, further comprising counter-measuring security activity initiated by the unauthorized or threatening IEEE 802.11 devices by activating counter-measuring means which operatively interfacing with said network appliance subsystem and launching neutralizing and/or disabling counter-measures against a suspected device.

18. The method for monitoring IEEE 802.11 wireless networks and detecting, neutralizing and locating unauthorized or threatening IEEE 802.11 devices entering said wireless networks of claims 14, further comprising counter-measuring security activity initiated by the unauthorized or threatening IEEE 802.11 devices by activating counter-measuring means which operatively interfacing with said network appliance subsystem and launching neutralizing and/or disabling counter-measures against a suspected device.
